(19) United States
(12) Patent Application Publication
(10) Pub. No.: US 2021/0056238 A1
(43) Pub. Date: Feb. 25, 2021

(54) INPUT DEVICE

(71) Applicant: OKI ELECTRIC INDUSTRY CO., LTD., Tokyo (JP)

(72) Inventor: Narihiro KITA, Tokyo (JP)

(73) Assignee: Oki Electric Industry Co., Ltd., Tokyo (JP)

(21) Appl. No.: 16/071,236

(22) PCT Filed: Dec. 21, 2016
(86) PCT No.: PCT/JP2016/088240

§ 371 Date: Jul. 19, 2018

(30) Foreign Application Priority Data
Feb. 26, 2016 (JP) 2016-035225

(51) Int. Cl. G06F 21/83; G06F 3/02; G06F 21/87; G06F 21/60

(52) U.S. Cl. CPC G06F 21/83; G06F 21/604; G06F 21/87; G06F 3/0202

(57) ABSTRACT

An input device includes a keyboard substrate and a protective detection net. The keyboard substrate includes an input button portion through which input is possible via a key operation, a sensitive-function-processing section that computes an output signal in accordance with an input signal from the input button portion, and a wiring line that connects the input button portion and the sensitive-function-processing section. The protective detection net covers an area surrounding the keyboard substrate, and is provided with tamper detection grid lines.

### TECHNICAL FIELD

The present disclosure relates to an input device, and in particular relates to an input device for performing input with a ten-key such as a PIN pad (personal identification number pad).

### BACKGROUND ART

In one such input device in related technology, a keyboard is disposed on an upper face of a case. A printed circuit board for keyboard processing is provided inside the case, whereby key operations are directly converted into electrical signals. The printed circuit board for keyboard processing is divided into a section for sensitive-function-processing and a section for non-sensitive-function-processing (for example, see the specification, etc., of Chinese Patent Application No. 100357864).

This keyboard is also provided with a sensitive-information protection mechanism that surrounds the sensitive-function-processing section in physical space. The sensitive-information protection mechanism is, for example, configured by a protective detection net that covers a secure microcomputer provided on the back face side of the printed circuit board.

When a sensitive-information-under-attack signal is generated in the sensitive-information protection mechanism, sensitive-information within the sensitive-function-processing section is destroyed.

### SUMMARY OF INVENTION

### Technical Problem

However, in the input device disclosed in the specification of Chinese Patent Application No. 100357864, signal lines for electrical signals traveling between a region provided with the sensitive-function-processing section and a region provided with the non-sensitive-function-processing section are physically vulnerable.

An object of the present disclosure is to provide an input device with improved tamper resistance that suppresses the external reading of electrical signals.

### Solution to Problem

An input device of the present disclosure includes a keyboard substrate and a protective detection net. The keyboard substrate includes an input button portion through which input is possible via a key operation, a sensitive-function-processing section that computes an output signal in accordance with an input signal from the input button portion, and a wiring line that connects the input button portion and the sensitive-function-processing section. The protective detection net covers an area surrounding the keyboard substrate, and is provided with tamper detection grid lines.

The area surrounding the keyboard substrate is thus covered by the protective detection net provided with the tamper detection grid lines. Attempts from outside to read electrical signals flowing in the wiring line are thus able to be detected using the tamper detection grid lines.

### Advantageous Effects of Invention

The present disclosure is able to provide an input device with improved tamper resistance that suppresses the external reading of electrical signals.

### BRIEF DESCRIPTION OF DRAWINGS

FIG. 1A is a vertical cross-section of relevant portions of an input device of an exemplary embodiment.

FIG. 1B is a plan view illustrating a portion viewed along arrow A in FIG. 1A.

FIG. 2 is a cross-section taken along line II-II in FIG. 1A to explain configuration of an input device of an exemplary embodiment.

FIG. 3 is an enlarged cross-section of section III in FIG. 1A to explain the configuration of relevant portions in an input device of an exemplary embodiment with respect to a comparative example.

### DESCRIPTION OF EMBODIMENTS

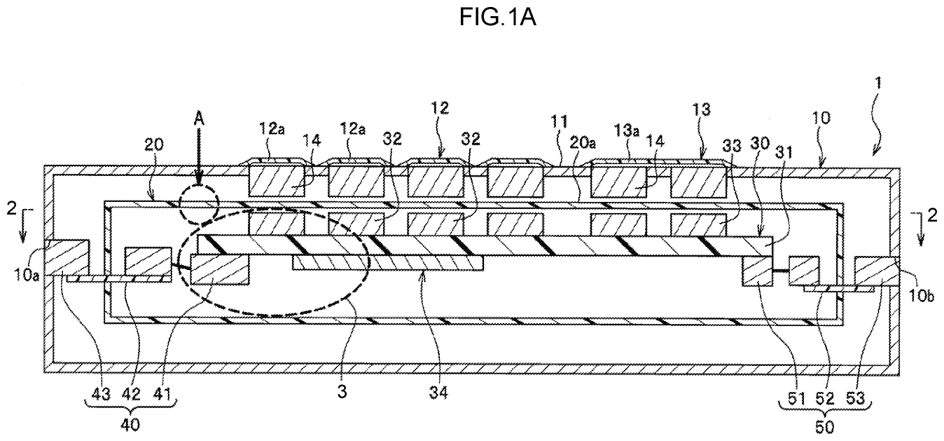

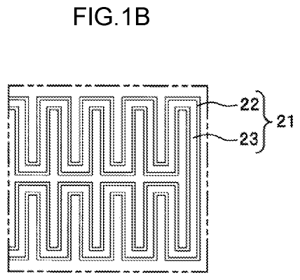

Detailed explanation follows regarding an exemplary embodiment of the present disclosure, with reference to FIG. 1A to FIG. 3. In the following explanation, identical elements are appended with identical reference signs, and duplicate explanation thereof is omitted.

FIG. 1A and FIG. 1B includes a vertical cross-section to explain the overall configuration of a PIN pad 1, which serves as an input device in the exemplary embodiment. FIG. 1A is a vertical cross-section of relevant portions thereof, and FIG. 1B is a plan view illustrating a portion viewed along arrow A in FIG. 1A.

Overall configuration will be described first. The PIN pad 1 mainly includes a casing 10 configuring an outer cover of the PIN pad 1, a protective case 20 configured in the shape of a hollow box, a keyboard substrate 30 that is disposed inside the protective case 20, and a USB connection section 40 and a function key connection section 50 for the input and output of signals to/from the outside.

Of these, the casing 10 is configured made from a synthetic resin or made from metal with a predetermined rigidity, and has a hollow, flattened cuboidal shape. Plural key tops 12a and 13a for respective ten-keys 12 and function keys 13 are provided on an upper face 11 of the casing 10. The key tops 12a and 13a are able to be displaced in an out-of-plane direction.

A rubber bushing 14, which serves as a cushioning member, is fixed to the lower face side of each of the key tops 12a and 13a.

The protective case 20 of the exemplary embodiment is mainly configured by a protective detection net 21. The protective detection net 21 includes flexible printed circuits (FPC) 23, on which tamper detection grid lines 22 have been laid in a predetermined pattern as illustrated in the enlarged portion viewed along the arrow A in FIG. 1A. The FPC are able to elastically deform in both a bending direction and an out-of-plane direction.

The protective case 20 of the exemplary embodiment is formed in a substantially flattened quadrangular box shape with smaller outer dimensions than that of the casing 10, and is supported suspended inside of the casing 10.

The keyboard substrate 30 is housed inside the protective case 20. The area surrounding the keyboard substrate 30 is covered by the protective detection net 21, isolating the keyboard substrate 30 from the outside.

Note that the protective detection net 21 is provided extending flatly across an upper face 20a of the protective case 20 of the exemplary embodiment, and the upper face 20a of the protective case 20 is configured so as to be capable of elastic deformation in an out-of-plane direction. The lower face and side faces of the protective case 20 may also be configured including a resin material or the like so as to have a predetermined rigidity.

Thus, pressing down on any of the key tops 12a or 13a provided to the casing 10 on the outside of the protective detection net 21 causes the protective detection net 21 to flex such that input button portions, described below, are able to be press-operated through the rubber bushing 14 from above the protective detection net 21.

The keyboard substrate 30 is configured including a quadrangular, flat plate shaped substrate 31, plural input button portions 32, 33 respectively corresponding to the ten-keys 12 and the function keys 13 through which key operations are able to be input, and a secure microcomputer 34 serving as a sensitive-function-processing section that computes output signals in accordance with input signals from the input button portions 32, 33.

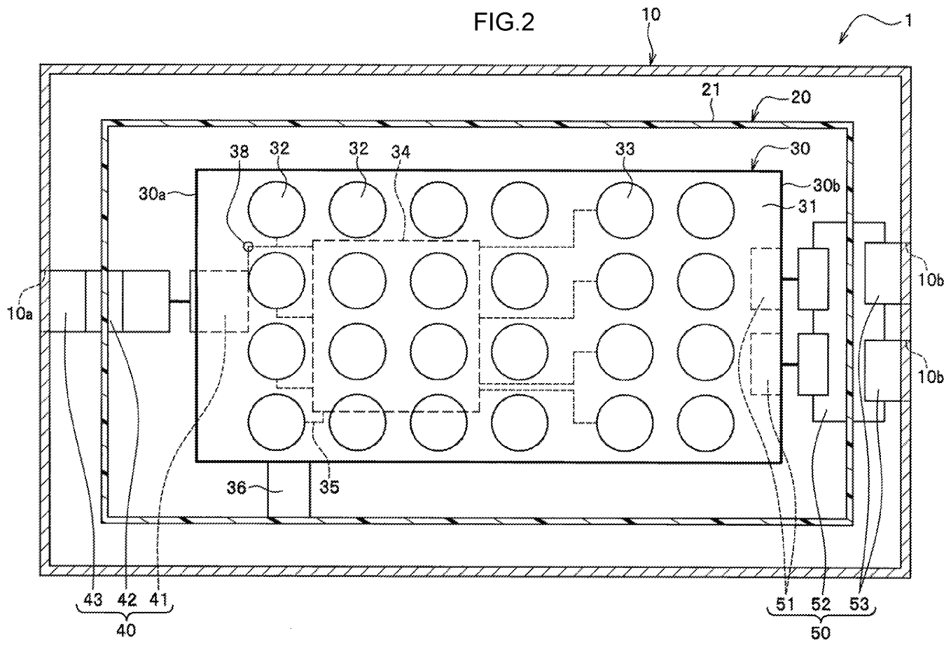

FIG. 2 is a cross-section taken along line II-II in FIG. 1A to explain configuration of the PIN pad 1 of the exemplary embodiment.

The keyboard substrate 30 of the exemplary embodiment is also configured including wiring lines 35 that connect the input button portions 32, 33 and the secure microcomputer 34.

The secure microcomputer 34 is connected to the tamper detection grid lines 22 of the protective detection net 21 through flexible connector wiring 36. The secure microcomputer 34 is configured so as to be able to detect disconnections by passing current to the tamper detection grid lines 22. Configuration may be such that the secure microcomputer 34 generates a sensitive-information-under-attack signal when a disconnection in the tamper detection grid lines 22 has been detected, such that sensitive-information in the secure microcomputer 34 is destroyed.

The USB connection section 40 includes a USB connector 41 that is mounted on one edge 30a of the keyboard substrate 30, a relay substrate 42 that is provided so as to pass through the protective case 20, and a USB connection port 43 that is provided in an opening 10a formed in the casing 10.

The function key connection section 50 includes a pair of function key connectors 51 that are mounted on another edge 30b of the keyboard substrate 30, a function key connector relay substrate 52 that is provided so as to pass through the protective case 20, and a pair of function key connector connection ports 53 that are provided in openings 10b formed in the casing 10.

In the exemplary embodiment, a sensitive-function-processing section inside the protective case 20 and a non-sensitive-function-processing section outside the protective case 20 are partitioned at the relay substrate 42 and the function key connector relay substrate 52.

Namely, in the exemplary embodiment, the USB connection port 43 provided in the opening 10a and the pair of function key connector connection ports 53 provided in the openings 10b belong to the non-sensitive-function-processing section.

Portions positioned inside the protective case 20, including the keyboard substrate 30, belong to the sensitive-function-processing section.

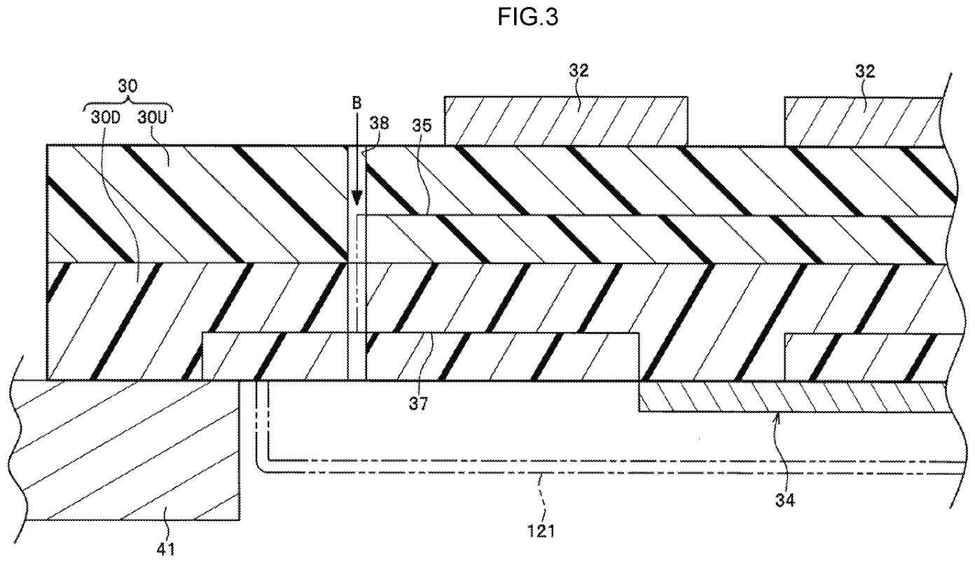

FIG. 3 is an enlarged cross-section of section III in FIG. 1A to explain the configuration of relevant portions in the PIN pad 1 of the exemplary embodiment with respect to a comparative example.

The keyboard substrate 30 of the exemplary embodiment has a two-layer structure in which a first layer 30U and a second layer 30D have been stacked.

Therein, in the first layer 30U, wiring lines 35 are laid from the input button portions 32, 33 disposed on the upper face side of the keyboard substrate 30.

In the second layer 30D, wiring lines 37 are laid from the secure microcomputer 34 disposed on the lower face side of the keyboard substrate 30.

The wiring lines 35, 37 are connected via through holes 38 that penetrate the first layer 30U and the second layer 30D.

The wiring lines 35, 37 running from the input button portions 32, 33 to the secure microcomputer 34 are physically vulnerable.

In one conceivable comparative example, configuration may be such that, for example, the lower face side of the keyboard substrate 30 is covered by a protective detection net 121 such as illustrated by the double-dotted dashed lines, thus surrounding the area around the secure microcomputer 34 performing non-sensitive-function-processing in physical space so as to configure a sensitive-function-processing section.

In such cases, if the protective detection net 121 is damaged, a sensitive-information protection mechanism generates a sensitive-information-under-attack signal. Sensitive-information within the sensitive-function-processing section is destroyed, thus providing protection without information being leaked to the outside.

However, with such a protective detection net 121, a physical attack from the upper face side of the through holes 38 such as illustrated by arrow B is possible.

In a known example of such a physical attack, a probe from a small signal detection substrate concealed inside the casing 10 of FIG. 1 is passed through a vulnerable portion of the PIN pad substrate, for example a through hole 38, so as to connect to a key top signal line in the vicinity of the secure microcomputer, enabling signals such as for a PIN number to be saved to memory.

Explanation follows regarding the operation and advantageous effects of the PIN pad 1 of the exemplary embodiment.

In consideration of the above, in the PIN pad 1 of the exemplary embodiment of the present disclosure, as illustrated in FIG. 1A and FIG. 2, the keyboard substrate 30 is housed within the protective case 20, for which the protective detection net 21 has been configured with a box shape.

The entire area surrounding the keyboard substrate 30 on which the input button portions 32, 33 are disposed is therefore covered by the tamper detection grid lines 22 embedded in the protective detection net 21.

Thus, as illustrated in FIG. 3, if an attempt was made to probe the keyboard substrate 30 via a through hole 38 such as illustrated by the arrow B, the tamper detection grid lines 22 would be broken at some portion of the protective detection net 21 illustrated in FIG. 1A and FIG. 2.

The sensitive-information protection mechanism would accordingly generate a sensitive-information-under-attack signal and any sensitive information would be destroyed. Thus, electrical signals flowing in the wiring lines 35, 37 running from the input button portions 32, 33 to the secure microcomputer 34 cannot by used to read sensitive information from the outside.

By covering the entire keyboard substrate 30 with the protective detection net 21 in this manner, vulnerable portions of the wiring lines 35, 37 connecting the input button portions 32, 33 and the secure microcomputer 34 are covered by the tamper detection grid lines 22 without any gaps in the coverage thereof. This enables improved tamper resistance in the PIN pad 1 of the exemplary embodiment.

Further, the entire keyboard substrate 30 is covered by the protective detection net 21. There is thus no need to separately cover the area surrounding the secure microcomputer 34 performing non-sensitive-function-processing with a protective detection net 121 such as that illustrated by the double-dotted dashed lines in FIG. 3. This enables an increase in the number of components to be suppressed.

Moreover, in key operations, the key tops 12a and 13a at the upper face 11 of the casing 10 illustrated in FIG. 1 are provided so as to be displaceable in the out-of-plane direction and are able to be pressed down.

This enables the protective detection net 21 to be flexed through the rubber bushing 14 such that the input button portions 32, 33 on the keyboard substrate 30 can be pressed downward to input positions from above the protective detection net 21.

The upper face 20a of the protective case 20 of the exemplary embodiment is thus formed by the protective detection net 21 configured by the FPC 23. The upper face 20a is able to elastically deform in the out-of-plane direction. The tamper resistance of the PIN pad 1 of the exemplary embodiment is thereby able to be improved without any loss of key operability.

As described above, with the PIN pad 1 of the exemplary embodiment, the area surrounding the keyboard substrate 30 is covered by the protective detection net 21 provided with the tamper detection grid lines 22. The wiring lines 35, 37 are provided running from the input button portions 32, 33 to the secure microcomputer 34 on the keyboard substrate 30.

Physically vulnerable wiring lines are thus housed inside the protective detection net 21, enabling attempts from the outside to read electrical signals flowing in the wiring lines to be detected by the protective detection net 21 provided with the tamper detection grid lines 22.

The exemplary embodiment is thus able to provide a PIN pad 1 with improved tamper resistance that suppresses the external reading of electrical signals.

Although an input device according to an exemplary embodiment has been described in detail above, the present disclosure is not limited to such an exemplary embodiment, and modifications may be made as appropriate within a range not departing from the spirit of the present disclosure.

For example, although explanation was given in which the PIN pad 1 served as an input device in the exemplary embodiment, there is no particular limitation thereto. Any input device may be employed so long as it includes input buttons through which key operations are able to be input, for example, the input device may be a ten-key employed in a keyboard unit of an automated transaction device such as an automated teller machine, or may be another input device employed when inputting a PIN number.

Further, the protective case 20 of the exemplary embodiment is disposed inside the casing 10, and is formed in a substantially flattened quadrangular box shape with smaller outer dimensions than that of the casing 10. However, there is no particular limitation thereto, and the shape of the protective case 20 may be a box shape with the dimensions of its three sides having another ratio. The protective case 20 may have any dimensions and any shape so long as it covers the area surrounding the keyboard substrate. For example, the protective case 20 may be a bottomed, flattened circular tube shape, a circular (encompassing ellipses and ovals) column shape, or a polygonal column shape.

1. An input device comprising:
a keyboard substrate including:
an input button portion through which input is possible via a key operation,
a sensitive-function-processing section that computes an output signal in accordance with an input signal from the input button portion, and
a wiring line that connects the input button portion and the sensitive-function-processing section; and
a protective detection net that covers the keyboard substrate, and that is provided with tamper detection grid lines.

2. The input device of claim 1, wherein:
the protective detection net is formed in a box shape that internally houses the keyboard substrate and isolates the keyboard substrate from an exterior, the protective detection net being a protective case, at least a face of which on an input button portion side is capable of elastic deformation.

3. The input device of claim 1, further comprising:
a casing on an outer side of the protective detection net,
the casing being provided with a key top positioned so as to be capable of press-operating the input button portion through the protective detection net by being pressed down.

4. An automated teller machine comprising an input device, wherein:
the input device includes:
a keyboard substrate including:
an input button portion through which input is possible via a key operation,
a sensitive-function-processing section that computes an output signal in accordance with an input signal from the input button portion, and
a wiring line that connects the input button portion and the sensitive-function-processing section; and
a protective detection net that covers the keyboard substrate, and that is provided with tamper detection grid lines.
